(19) United States
(12) Patent Application Publication
(10) Pub. No.: US 2026/0319846 A1
(43) Pub. Date: Oct. 15, 2026

(54) DEDICATED SCHEDULING CHIP FOR GRAPHICS PROCESSING UNIT IN A CLOUD SERVER

(71) Applicant: ADVANCED MICRO DEVICES, INC., Santa Clara, CA (US)

(72) Inventor: Ahmet Artu Yildirim, Issaquah, WA (US)

(21) Appl. No.: 19/176,319

(22) Filed: Apr. 11, 2025

(51) Int. Cl. G06F 9/50

(52) U.S. Cl. CPC G06F 9/5027

(57) ABSTRACT

A system, such as a cloud computing system, includes one or more parallel processing units configured to provide virtual resources for a server. The system also includes scheduling circuitry configured to communicate with a control plane service for the server via a first network interface. The scheduling circuitry provides information indicating an available portion of the virtual resources to the control plane service via the first network interface and allocates the available portion to one or more tasks determined by the control plane service. The scheduling circuitry can also initiate execution of the task(s) using the available portion of the virtual resources of the parallel processing unit. In some cases, the system also includes a memory system that stores information in buffers or memory locations and a second network interface to convey information between the memory system and the parallel processing unit(s).

### BACKGROUND

A conventional cloud computing system includes a central processing unit (CPU), one or more memory stores, a set of parallel processing units (such as graphics processing units, GPUs), and interconnections such as buses, scalable data fabrics, or other networks or subnetworks to convey information between these entities. The parallel processing units typically support virtualization that allows multiple virtual machines to share the hardware resources of the parallel processing units. Each virtual machine executes as a separate process using the hardware resources of one or more of the parallel processing units. Some virtual machines, which are also referred to as guest machines or guests, implement an operating system to emulate an actual machine; other virtual machines execute code in a platform-independent environment. A processing unit (such as the CPU) implements a hypervisor that creates and runs the virtual machines using shared memory and computing resources of the parallel processing units. Physical function circuitry performs different functions for the CPU. The physical function circuitry can also be referred to as “the physical function.” The physical function can support one or more virtual functions that are connected to the virtual machines and share the resources of the physical function on a time-sliced or time-multiplexed basis. For example, the physical function can be allocated to a first virtual function running on a first virtual machine in a first time interval and the physical function can be allocated to a second virtual function running on a second virtual machine in a subsequent second time interval. The single root input/output virtualization (SR IOV) specification allows multiple virtual machines to share a processor interface to a single bus, such as a peripheral component interconnect express (PCIe) bus. Components access virtual functions by transmitting requests over the bus.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a cloud computing system that implements parallel processing units that include integrated scheduling circuitry used to allocate virtual resources for the parallel processing units, according to some embodiments.

FIG. 2 illustrates a relationship between a packet transmitted over a dedicated channel of a network interface and locations in a memory referenced by the packet, according to some embodiments.

FIG. 3 illustrates a method of utilizing virtual resources of parallel processing units using a control plane service and scheduling circuitry integrated with the parallel processing units, according to some embodiments.

### DETAILED DESCRIPTION

Machine learning (ML) models, which include artificial intelligence (AI) models and techniques, are often implemented on cloud computing systems. Training an ML model or performing inference on a trained ML model requires performing large numbers of operations on vectors, matrices, and tensors that store input vectors and parameters that represent the ML model. For example, generative AI models (such as large language models, LLMs) include hundreds of billions of parameters and typically run on arrays of parallel processors deployed in a cloud computing system. A hypervisor executing on the CPU of the cloud computing system partitions the training or inference tasks, allocates resources of the virtual machines (VMs) executing on the parallel processors in the cloud computing system to the partitions, and schedules serial execution of the tasks in the partitions on the VMs. Once the VMs have completed their partitioned tasks, the results are merged or gathered and then written back to memory. However, software-based scheduling systems such as those implemented by the hypervisor introduce significant latency, overhead, and potentially unfair resource allocation. For example, serializing task execution at the hypervisor increases overhead, slows down task completion, and reduces overall performance of parallelizable tasks performed during training or inference. These problems are exacerbated in multi-tenant cloud computing systems that support multiple concurrent users that are training or performing inference on different ML models, as well as other applications that can be executing in the multi-tenant cloud computing system.

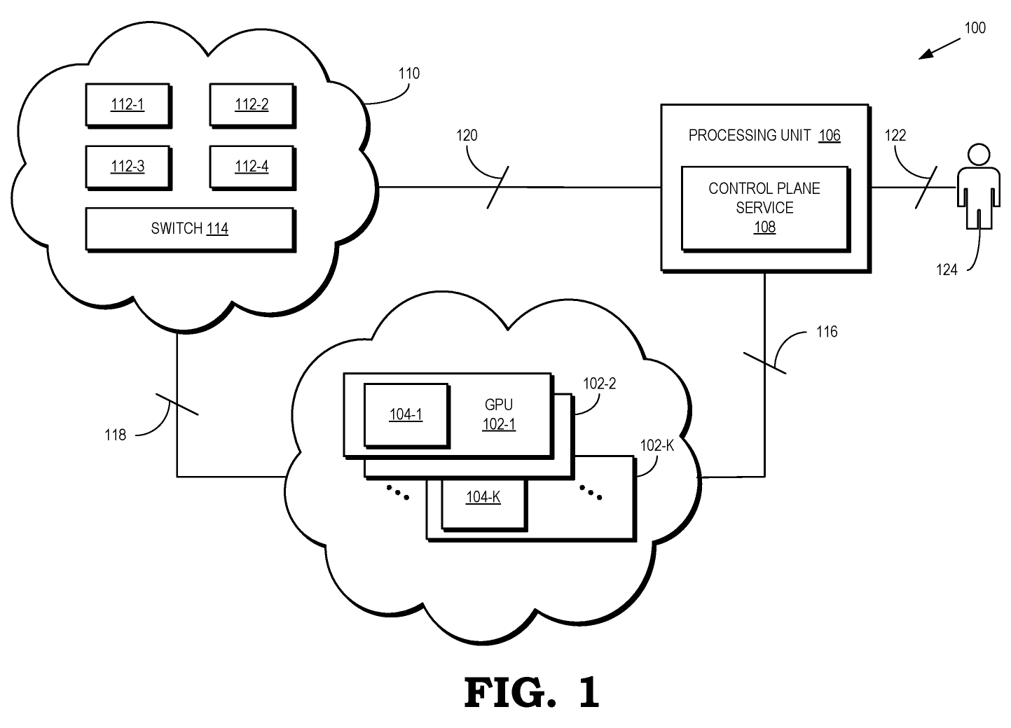

FIGS. 1-3 illustrate systems, apparatuses, and methods that integrate a scheduling chip within a parallel processing unit (such as a GPU) that is configured to provide virtual resources to the cloud computing system. The scheduling chip is configured to communicate with a control plane service via a dedicated network channel. As used herein, the term “dedicated” is used to refer to a network channel that is constrained to convey information between the control plane service and the scheduling chip. The dedicated network channel bypasses the hypervisor in the cloud computing system CPU because the hypervisor is not needed to allocate or manage virtual resources of the parallel processing units that include the scheduling chip. Thus, the CPU does not necessarily implement a hypervisor, although the CPU can implement a hypervisor to allocate resources of a subset of the parallel processing units that differs from another subset of the parallel processing units that are connected to the control plane service via the dedicated network channel. The scheduling chips on the parallel processing units can provide information indicating their available virtual resources to the control plane service via the dedicated network. Based on the available virtual resources, the control plane service can allocate portions of the available virtual resources to one or more tasks. The control plane service then transmits network packets over the dedicated network interface to initiate the tasks on one or more of the parallel processing units. In some embodiments, the network packets include task information such as native code for the parallel processing units, remote buffer pointers for task parameters associated with an ML model, pointers to tensor values associated with the ML model, and the like. The pointers can reference buffers or memory locations in a remote memory system that includes one or more high-capacity memory storage elements that are interconnected, e.g., by a Compute Express Link (CXL). In response to receiving a network packet, a scheduling chip allocates virtual resources of the corresponding parallel processing unit and initiates execution of one or more tasks using the allocated resources. The scheduling chip can also control resource distribution, load management, or task prioritization on the parallel processing units.

FIG. 1 is a block diagram of a cloud computing system 100 that implements parallel processing units 102 that include integrated scheduling circuitry 104 used to allocate virtual resources for the parallel processing units 102, according to some embodiments. The cloud computing system 100 can also be referred to as a cloud server 100 a cloud server system 100 or a processing system 100, among other names. The scheduling circuitry 104 can be implemented as separate or discrete integrated circuits, or “chips”, that are integrated with corresponding parallel processing units, as discussed herein. The scheduling circuitry 104 can therefore be implemented as hardcoded/hardwired circuitry, such as circuitry of an ASIC, programmable circuitry, such as an FPGA, one or more processors executing software/executable instructions, or some combination thereof. The scheduling circuitry 104 is therefore referred to as “a scheduling chip 104” or “the scheduling chips 104.”

The cloud computing system 100 includes a processing unit 106, such as a CPU, that is implemented with circuitry including one or more processor cores (not shown in FIG. 1 in the interest of clarity) that execute instructions concurrently or in parallel. The processor cores include circuitry to implement one or more compute units such as single-instruction, multiple data (SIMD) units that perform the same operation on different data sets to produce one or more results.

The processing unit 106 includes circuitry configured to implement a control plane service 108 that performs operations such as determining paths or routes taken by data that flows through the cloud computing system 100. Some embodiments of the control plane service 108 use routing protocols to determine the best path for information to take between devices within the cloud computing system 100. For example, the control plane service 108 can implement Multiprotocol Label Switching (MPLS), where the control plane service 108 determines the optimal route for data to travel through a network, then assigns it a unique label before sending it on to the data plane (not shown in FIG. 1 in the interest of clarity). The data plane is the part of the network architecture responsible for moving data packets. Functions performed by the control plane service 108 include, but are not limited to, routing packets, maintaining network topology, traffic management, load-balancing, and managing availability of resources in the cloud computing system 100.

In the illustrated embodiment, the parallel processing units 102 include circuitry to implement one or more processor cores (not shown in FIG. 1 in the interest of clarity) that each operate as a compute unit configured to perform one or more operations based on one or more instructions received by the parallel processing units 102. The compute units in the processor cores are implemented as circuitry for one or more single-instruction, multiple data (SIMD) units that perform the same operation on different data sets to produce one or more results. Although three parallel processing units 102 are shown in FIG. 1, more or fewer parallel processing units 102 can be implemented in other embodiments of the cloud computing system 100. Examples of parallel processing units 102 include GPUs, general-purpose GPUs (GPGPUs), neural processing units (NPUs), tensor processing units (TPUs), intelligence processing units (IPUs) or other vector processor or type of parallel processor.

The cloud computing system 100 also includes a memory system 110 or other storage component. In the illustrated embodiment, the memory system 110 includes circuitry configured to implement a non-transitory computer-readable medium such as a dynamic random-access memory (DRAM). However, some embodiments of the memory system 110 are implemented using other types of memory including, for example, static random-access memory (SRAM), nonvolatile RAM, and the like. In the illustrated embodiment, the memory system 110 is a high-capacity system that includes a set of memory nodes 112 that are interconnected by a switch 114 such as a CXL switch. Buffers or memory locations in the memory system 110 are addressed and accessed using addresses from a global address space. For example, in response to receiving a memory access request including a global address that references a buffer or memory location in one of the memory nodes 112, switch 114 serves the request by accessing the buffer or memory location based on the global address. The memory system 110 can store information representing instructions such as native code for one or more applications (e.g., graphics applications, compute applications, ML/AI models or applications), parameters or tensor values associated with the applications, and results produced by executing the program code, e.g., using virtual resources of the GPUs 102.

The cloud computing system 100 supports network interfaces that are implemented with circuitry that supports communication between entities in the cloud computing system 100. Some implementations of the cloud computing system 100 include other buses, bridges, switches, routers, and the like, which are not shown in FIG. 1 in the interest of clarity. The cloud computing system 100 includes a network interface 116 that supports a dedicated channel between the control plane service 108 and the switching circuitry 104. As discussed herein, the dedicated channel of the network interface 116 is configured to convey information including availability of virtual resources of the GPUs 102, as well as packets including information indicating allocation of tasks (by the control plane service 108) to the available virtual resources, allocation of native code for execution on the GPUs 102, global addresses that refer to buffers or memory locations in the memory system 110, and the like. In the illustrated embodiment, the cloud computing system 100 also includes a network interface 118 between the GPUs 102 and the memory system 110, a network interface 120 between the control plane service 108 and the memory system 110, and a network interface 122 between users 124 of the cloud computing system 100 and the processing unit 106.

The scheduling circuitry 104 in GPUs 102 is configured to communicate with the control plane service 108 via the network interface 116. The scheduling circuitry 104 provides information indicating an available portion of the virtual resources of the corresponding parallel processing unit 102 to the control plane service 108. In response to receiving the information indicating the available portion, the control plane service 108 allocates a subset (i.e., some or all) of the available portion to one or more tasks. For example, the tasks can include matrix multiplications performed on matrices or tensors representing an ML model or an input matrix to the ML model. The matrix multiplications can be performed during training of the ML model or performing inference using the ML model. The control plane service 108 transmits or conveys information indicating the task(s) and the subset of the available portion of the virtual resources to the scheduling circuitry 104 via the dedicated channel of the network interface 116. In response to receiving the information allocating the available portion of the virtual resources for executing the tasks, the scheduling circuitry 104 initiates execution of the task(s) using the available portion of the virtual resources of the corresponding parallel processing unit 102.

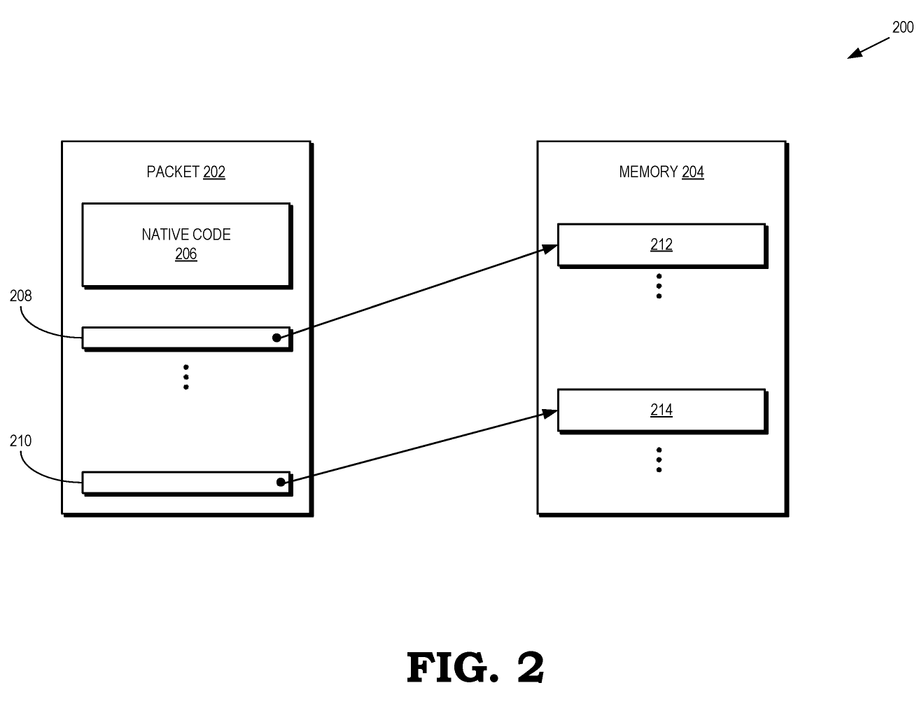

FIG. 2 illustrates a relationship 200 between a packet 202 transmitted over a dedicated channel of a network interface and locations in a memory 204 referenced by the packet 202, according to some embodiments. A control plane service such as the control plane service 108 shown in FIG. 1 transmits the packet 202 over a dedicated channel of a network interface such as the network interface 116 shown in FIG. 1. The packet 202 is then received by scheduling circuitry integrated with a parallel processing unit, such as the scheduling circuitry 104 associated with the GPUs 102 shown in FIG. 1.

In the illustrated embodiment, the packet 202 includes native code 206 that can be executed on a parallel processing unit to perform one or more tasks or operations. As used herein, the term “native” refers to code that is understood by a corresponding parallel processing unit (or virtual resources implemented using the parallel processing unit) and can therefore be executed by the parallel processing unit (or the virtual resources) to perform one or more tasks. For example, the native code 206 can include instructions that, when executed, cause a GPU to perform tasks including matrix multiplications that are performed during training of an ML model or inference using a previously trained ML model.

The packet 202 also includes a (first) pointer 208 and a (second) pointer 210 that reference buffers 212 or memory locations 214 in a corresponding memory 204. Some embodiments of the memory 204 are implemented as a portion of the memory system 110 shown in FIG. 1. In some embodiments, the first pointer 208 references a buffer 212 that stores information representing one or more parameters (such as a parameter of an ML model) associated with one or more tasks defined by the native code 206. The second pointer 210 references a memory location 214 that stores information representing one or more tensor values associated with the task(s) defined by the native code. For example, the tensor values can represent a base matrix or tensor of the ML model, an input vector or matrix to the ML model, and the like.

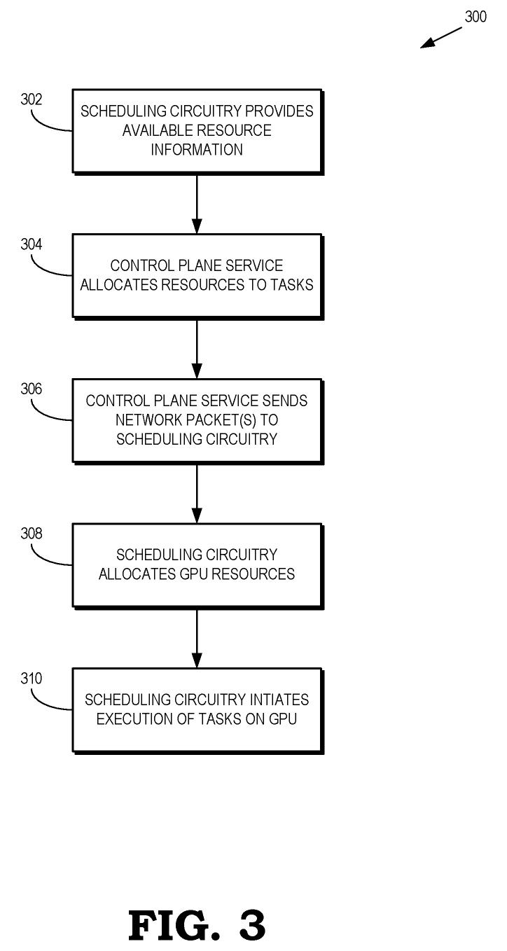

FIG. 3 illustrates a method 300 of utilizing virtual resources of parallel processing units using a control plane service and scheduling circuitry integrated with the parallel processing units, according to some embodiments. The method 300 is implemented in some embodiments of the cloud processing system 100 shown in FIG. 1.

At block 302, the scheduling circuitry provides information indicating available virtual resources on the associated parallel processing unit(s). The information is provided over a dedicated channel of a network interface between the scheduling circuitry and the control plane service. In some embodiments, the scheduling circuitry and the control plane service communicate according to a hardware -assisted virtualization technology such as the single root input/output virtualization (SR IOV) specification that supports multiple virtual machines. The SR IOV specification enables the control plane service to partition a parallel processing unit into one or more virtual machines. A subset (or all) of the virtual machines executing on the parallel processing unit can be reserved for management by the scheduling circuitry so that the available virtual resources are properly utilized while avoiding potential management problems such as resource competition with hypervisors running on the same host.

At block 304, the control plane service allocates virtual resources of the parallel processing unit to tasks in response to receiving the information indicating the available virtual resources. For example, the control plane service can estimate the memory and processing resources that are needed to execute one or more tasks and then allocate a portion of the virtual resources that is sufficient to execute the tasks.

At block 306, the control plane service sends one or more network packets to the scheduling circuitry. As discussed herein, the network packets can include native code and pointers to buffers or memory locations in a memory such as the memory system 110 shown in FIG. 1. For example, the network packet can include native GPU code and remote buffer pointers that reference buffers in a remote memory system such as a CXL memory system that interconnects high-speed, high-capacity memory storage with parallel processing units (e.g., GPUs) that are deployed in the same cloud computing system. Some embodiments of this architecture permit asynchronous execution of fine-grained AI tasks without the need for a hypervisor to manage the virtual machines. Removing the need for hypervisors to serialize task execution allows tasks to run in parallel on the parallel processing units with less overhead, which supports faster task completion and higher performance. Parallelizing the tasks also increases overall system throughput.

At block 308, the scheduling circuitry allocates virtual resources of the parallel processing units in response to receiving the network packet(s). For example, the scheduling circuitry can allocate one or more virtual machines executing on the parallel processing units, as well as corresponding memory, to execute native code received in the network packet(s). The scheduling circuitry can also retrieve information stored at locations indicated in one or more pointers received in the network packet(s), e.g., by retrieving information stored in buffers or memory locations that are referenced by the pointers.

At block 310, the scheduling circuitry initiates execution of one or more tasks using the virtual resources of the parallel processing unit(s). In some embodiments, the scheduling circuitry also controls resource distribution, manages the load on the virtual resources for the parallel processing units, and prioritizes tasks for execution using the virtual resources of the parallel processing units. Tasks are then initiated according to the task prioritization using the allocated virtual resources. The scheduling circuitry can also perform real-time dynamic changes to the resource allocation, which is beneficial to fine-grained AI routines that can require real-time responses and precise timing.

Integrating scheduling circuitry into the parallel processing units provides several advantages over conventional hypervisor management of virtual resources of the parallel processing units. For example, the control plane service can manage multiple parallel processing units in data centers or other cloud computing systems and therefore has a holistic view of the available resources. Allowing the control plane service to interact directly with the scheduling circuitry via a dedicated channel of the network interface supports highly scalable management of fine-grained AI tasks in large cloud computing systems. The scheduling circuitry can also be configured with different scheduling policies, which adds versatility to support ML, AI, and other general computation tasks. Cloud service providers can optimize scheduling policies according to specific use cases by customizing the control plane service, the scheduling circuitry, or a combination thereof. In some embodiments, the control plane service and the scheduling circuitry can isolate workloads at the hardware level, which improves security by preventing resource hijacking.

In some embodiments, certain aspects of the techniques described above are implemented by one or more processors of a processing system executing software. The software includes one or more sets of executable instructions stored or otherwise tangibly embodied on a non-transitory computer readable storage medium. The software can include instructions and data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the embodiments disclosed above may be altered or modified and all such variations are considered within the scope of the disclosed subject matter. Accordingly, the protection sought herein is as set forth in the claims below.

What is claimed is:

1. An apparatus comprising:
a parallel processing unit configured to provide virtual resources for a server; and
scheduling circuitry configured to communicate with a control plane service for the server via a first network interface, wherein the scheduling circuitry is configured to provide information indicating an available portion of the virtual resources of the parallel processing unit to the control plane service via the first network interface, allocate at least a subset of the available portion to at least one task determined by the control plane service, and initiate execution of the at least one task using at least the allocated subset of the available portion of the virtual resources of the parallel processing unit.

2. The apparatus of claim 1, wherein the scheduling circuitry is configured to receive at least one packet from the control plane service via the first network interface and to initiate execution of the at least one task in response to receiving the at least one packet.

3. The apparatus of claim 2, wherein the at least one packet comprises at least one of native code representing the at least one task to be executed by the available portion of the virtual resources of the parallel processing unit, a first pointer to a parameter of the at least one task, or a second pointer to at least one tensor value associated with the task.

4. The apparatus of claim 3, wherein the at least one task is executed to perform training or inference for a machine learning (ML) model, and wherein the parameter indicated by the first pointer comprises at least one parameter of the ML model.

5. The apparatus of claim 4, wherein the at least one tensor value is associated with at least one tensor that represents the ML model.

6. The apparatus of claim 3, wherein at least one of the first pointer or the second pointer references a buffer or a memory location in a memory system that comprises high-capacity memory storage elements.

7. The apparatus of claim 2, wherein the at least one packet comprises information indicating a subset of the available portion of the virtual resources that the control plane service has allocated for execution of the at least one task, and wherein the scheduling circuitry is configured to allocate the subset to the at least one task in response to receiving the at least one packet.

8. The apparatus of claim 1, wherein the scheduling circuitry is configured to control at least one of resource distribution, load management, or task prioritization on the parallel processing unit.

9. A method comprising:
conveying, from scheduling circuitry in a parallel processing unit to a control plane service via a first network interface, information indicating an available portion of virtual resources of the parallel processing unit;
receiving at the scheduling circuitry, from the control plane service via the first network interface, information indicating at least one task and a subset of the available portion of the virtual resources to be allocated to the at least one task; and
executing, using the subset, the at least one task on the parallel processing unit.

10. The method of claim 9, further comprising:
controlling, using the scheduling circuitry, at least one of a resource distribution, load management, or task prioritization for the at least one task executing on the parallel processing unit.

11. The method of claim 9, wherein receiving the information from the control plane service comprises receiving at least one packet from the control plane service at the scheduling circuitry via the first network interface.

12. The method of claim 11, wherein executing the at least one task on the parallel processing unit comprises:
allocating, using the scheduling circuitry, the subset to the at least one task in response to receiving the at least one packet; and
initiating, using the scheduling circuitry, the at least one task in response to receiving the at least one packet.

13. The method of claim 11, wherein the at least one packet comprises at least one of native code representing the at least one task to be executed by the available portion of the virtual resources of the parallel processing unit, a first pointer to a parameter of the at least one task, or a second pointer to at least one tensor value associated with the task.

14. The method of claim 13, wherein executing the at least one task comprises performing training or inference for a machine learning (ML) model, and wherein the parameter indicated by the first pointer comprises at least one parameter of the ML model.

15. The method of claim 14, wherein the at least one tensor value is associated with at least one tensor that represents the ML model.

16. The method of claim 13, further comprising:
receiving, from a memory system via a second network interface of the parallel processing unit, information stored in a buffer or a memory location that is referenced by at least one of the first pointer or the second pointer; and
executing, on the parallel processing unit, the at least one task based on the information stored in the buffer or the memory location.

17. A system comprising:
a first processing unit configured to implement a control plane service for a server; and
a plurality of parallel processing units including scheduling circuitry and configured to provide virtual resources for the server; wherein the scheduling circuitry is configured to provide information indicating an available portion of the virtual resources to the control plane service via a first network interface, allocate the available portion to at least one task determined by the control plane service, and initiate execution of the at least one task using the available portion of the virtual resources.

18. The system of claim 17, wherein the scheduling circuitry is configured to receive at least one packet from the control plane service via the first network interface and to initiate execution of the at least one task in response to receiving the at least one packet.

19. The system of claim 18, further comprising:
a memory system configured to store information in at least one of a buffer or a memory location; wherein the memory system is configured to convey information to the plurality of parallel processing units, wherein the plurality of parallel processing units are configured to execute the at least one task based on the information stored in the buffer or the memory location.

20. The system of claim 19, wherein the at least one packet comprises at least one of native code representing the at least one task to be executed using the available portion of the virtual resources of the plurality of parallel processing units, a first pointer to a parameter of the at least one task stored in the buffer, or a second pointer to at least one tensor value stored in the memory location.
